(19) United States
(12) Patent Application Publication
(10) Pub. No.: US 2017/0293962 A1
(43) Pub. Date: Oct. 12, 2017

(54) MOBILE GIFT APPLICATION FOR IDENTIFYING AND BUYING PRESENTS AND GIFTS

(71) Applicant: Kanwaldeep Kaur Sekhon, Floral Park, NY (US)

(72) Inventor: Kanwaldeep Kaur Sekhon, Floral Park, NY (US)

(21) Appl. No.: 15/453,820

(22) Filed: Mar. 8, 2017

Related U.S. Application Data
(60) Provisional application No. 62/305,511, filed on Mar. 8, 2016.

(51) Int. Cl. G06Q 30/06

(52) U.S. Cl. CPC G06Q 30/0631

(57) ABSTRACT

A gift generating system for a user. The system includes a computing system, configured to store giftee information in a customer database, wherein the giftee information is associated with a selected giftee, and wherein the computing system is configured to generate a customized gift recommendation based on the giftee information. The system further includes a mobile device, used by the user, in communication with the computing system, configured to: i) transmit the giftee information to the computing system from the user; ii) receive the customized gift recommendation associated with the giftee information from the computing system; and iii) receive purchase locations for the customized gift recommendation from the computing system.

### CROSS-REFERENCE TO RELATED APPLICATION

The present application is related to and claims priority from prior provisional application Ser. No. 62/305,511, filed Mar. 8, 2016 which application is incorporated herein by reference.

### BACKGROUND OF THE INVENTION

### Field of the Invention

This invention lies in the field of smart phone or mobile gift application s. In particular there is an gift application that assists a user in identifying and buying presents and gifts for others.

### Background of the Invention

A mobile gift application is a computer program designed to run on smartphones, tablet computers and other mobile devices. Mobile applications were originally offered for general productivity and information retrieval, including email, calendar, contacts, and stock market and weather information. The explosion in number and variety of applications made discovery a challenge, which in turn led to the creation of a wide range of review, recommendation, and creation sources, including blogs, magazines, and dedicated online app-discovery services. Many new applications are desirable to provide convenient solutions to the users.

Various attempts have been made to solve problems found in mobile gift applications (apps) art, whereby the following prior art is hereby incorporated by reference for their supportive teachings, and include:

U.S. Publication No. 2013/0268391 to Esch et al.

U.S. Publication No. 2013/0268391 to Argue et al.

U.S. Publication No. 2014/0143086 to Birsin et al., published on May 22, 2014, filed on Nov. 16, 2012 with app. No. 13/679,658, and teaches of a customized recommendations based on customer information.

U.S. Publication No. 2012/0278127, pub. on Nov. 1, 2012, filed on Apr. 28, 2011, teaching of a generating product recommendations based on dynamic product context data and social activity data related to a product.

U.S. Pat. No. 7,373,313 issued to Kahle et al., issued on May 13, 2008, describes a service for enabling users to share information regarding products represented on web pages.

The foregoing patents reflect the state of the art of which the applicant is aware and are tendered with the view toward discharging applicant's acknowledged duty of candor in disclosing information which may be pertinent in the examination of this gift application. It is respectfully stipulated, however, that none of these patents teach or render obvious, singly or when considered in combination, applicant's claimed invention.

Therefore, a long-standing need has existed to provide a novel means by which the user can be effectively informed of what gifts are available that fit the giftees preferences.

### SUMMARY OF THE ILLUSTRATED EMBODIMENTS

In view of the foregoing disadvantages inherent in the known art, the present invention provides a novel gift application that assists a user in identifying and buying presents and gifts for others. The general purpose of the present invention, which will be described subsequently in greater detail, is to provide help for users to find the perfect gift for anyone. The user enters in a budget range and then selects answers about the recipient ranging from gender and age to hobbies and interests. The gift application then generates a list of choices which include pictures, prices, and details of the items. The gift application assists a user in identifying and buying presents and gifts for others is designed to locate gifts within the specified price range. If the gift application can't find anything, alternatively, based on the individual's preferences, gift cards may be suggested.

According to primary aspect of the present invention, there is a gift generating system for a user. The system includes a computing system, configured to store giftee information in a customer database, wherein the giftee information is associated with a selected giftee, and wherein the computing system is configured to generate a customized gift recommendation based on the giftee information. The system further includes a mobile device, used by the user, in communication with the computing system, configured to: i) transmit the giftee information to the computing system from the user; ii) receive the customized gift recommendation associated with the giftee information from the computing system; and iii) receive purchase locations for the customized gift recommendation from the computing system.

In addition, the giftee information is selected from the group of questions consisting of: hobbies, brands, companies, categories of products, budget, past gifts, occasion, level of importance, relationship to user, likability, gender, and age.

Further the purchase locations are locations that are relatively close to the user.

Additionally the computing system further transmits the customized giftee information to other users that are in a communication network with the user.

Further the mobile device additionally transmits user gift information to the computing system from the user.

Additionally enabling the user to select a letter of the alphabet and thereby displaying a list of hobbies that begin with that letter, and thereby allow the user to select the hobby identify the giftee information about hobbies.

Further the user via the mobile device enters a list of past gifts sent to the giftee and transmits that past list to the computing system and thereby enables displaying of the past list of gifts associated with the selected giftee to the user when desired.

Moreover the giftee information about likeability is identified by enabling the user to select a number between 1 and 10.

Yet additionally the giftee information about level of importance is identified by enabling the user to select from a group of answers consisting of: extremely important, very important, important, and somewhat important.

Other aspects of the present invention will become apparent from time to time throughout the specification as hereinafter related. There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates an exemplary communication.

FIG. 2 illustrates exemplary components of the mobile devices of FIG. 1.

FIG. 3 illustrates one embodiment of an exemplary display.

FIG. 4 illustrates one embodiment of an exemplary display.

FIG. 5 illustrates one embodiment of an exemplary display.

FIG. 6 illustrates one embodiment of an exemplary display.

FIG. 7 illustrates one embodiment of an exemplary display.

FIG. 8 illustrates one embodiment of an exemplary display.

FIG. 9 illustrates one embodiment of an exemplary display.

FIG. 10 illustrates one embodiment of an exemplary display.

FIG. 11 illustrates one embodiment of an exemplary display.

FIG. 12 illustrates one embodiment of an exemplary display.

FIG. 13 illustrates one embodiment of an exemplary display.

FIG. 14 illustrates one embodiment of an exemplary display.

FIG. 15 illustrates one embodiment of an exemplary display.

FIG. 16 illustrates one embodiment of an exemplary display.

FIG. 17 illustrates one embodiment of an exemplary display.

FIG. 18 illustrates one embodiment of an exemplary display.

FIG. 19 illustrates one embodiment of an exemplary display.

FIG. 20 illustrates one embodiment of an exemplary display.

FIG. 21 illustrates one embodiment of an exemplary display.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

An exemplary system includes a remote computing system and a mobile device. The remote computing system is configured to store customer information in a customer database. The customer information is associated with an account identifier, and the remote computing system is configured to generate a customized recommendation based at least in part on the customer information. The customized recommendation may include recommendations for particular products, services, or both. The mobile device is in communication with the remote computing system and is configured to receive the customer information associated with the account identifier, and present the customized recommendation associated with the customer information. The customer information may consider various customer interests, such as hobbies, level of education, profession, etc.

The customer's interests may change over time or a representative may learn additional information about the customer. That additional information may be relevant to future recommendations. Accordingly, the mobile device may be further configured to present a representation of potential customer interests, receive a selection of at least one of the potential customer interests and receive an updated customized recommendation from the remote computing system based at least in part on the selected customer interest. The system allows representatives to consistently recommend products or services to customers based on the customer's perceived needs based on his or her interests. Moreover, because the customer information is synchronized between the mobile device and the remote computing system, the customer does not need to repeat his or her input when talking to other representatives.

The figures illustrate an exemplary system for providing product or service recommendations to mobile devices based on customer information, and particularly, upon the customer's interests. The system may take many different forms and include multiple and/or alternate components and facilities. While an exemplary system is shown in the figures, the exemplary components illustrated in the Figures are not intended to be limiting. Indeed, additional or alternative components and/or implementations may be used. For example, while the system is generally discussed in the context of a mobile device or tablet computer, alternative approaches may include implementing the system online, such as through an ecommerce website, or through other types of hardware, such as a desktop computer located at a point of sale or call center.

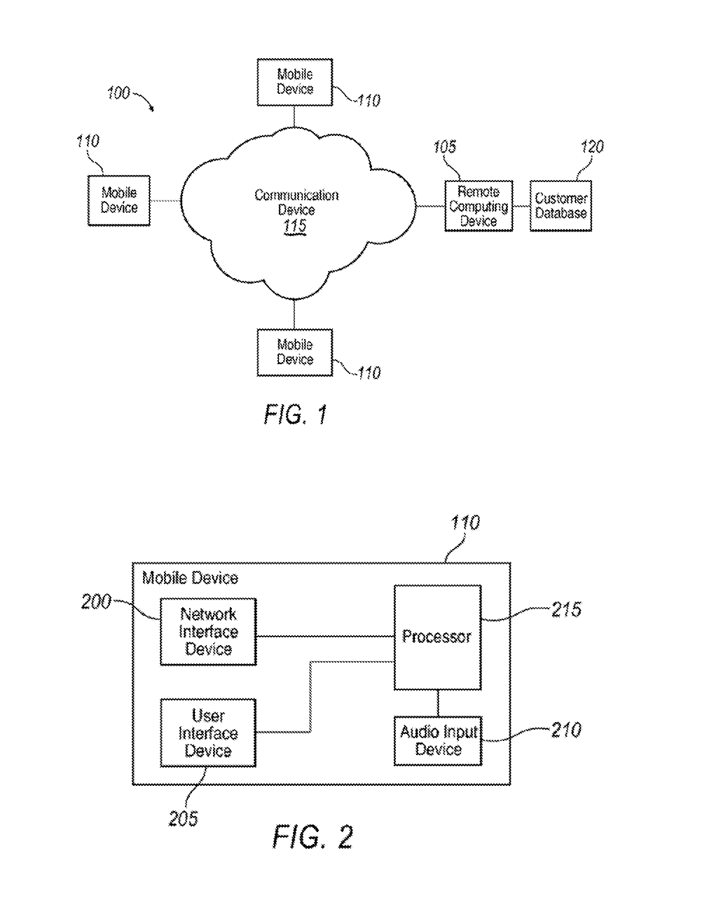

As illustrated in FIG. 1, a system 100 includes a remote computing system 105 and a plurality of mobile devices 110. Each mobile device 110 is configured to communicate with the remote computing system 105 over a communication network 115.

The remote computing system 105 may include any hardware device, such as one or more servers, configured to store customer information in a customer database 120 and provide a customized recommendation based on the customer information. Although illustrated as a single database, the information stored in the customer database 120 may be distributed among multiple databases. The customer database 120 may associate the customer information with an account identifier, and the customer information may include one or more customer profiles. Each customer profile may represent a particular customer. For instance, the customer information for a family of four may have four customer profiles and the selected receivers of future and past gifts associated with the account identifier. The name of each customer profile may correspond to one family member's name. The customer profile may further include information about the customer's perceived needs or choices based on interests communicated to a representative or personally inputted into the database by the customer as illustrated in the following figures. The customer may have told the representative about liking a particular sports team or having a particular hobby while the customer was shopping for or researching for a particular product for a gift. To help the customer identify a suitable product for a gift given the customer's interests or gift receivers interests the representative may have made a note of the customer's interest in the customer profile, and the customer profile that includes the customer's interests may be stored in the customer database 120. The remote computing system 105 may be configured to query the customer database 120 for the customer information, customer profiles, gift receiver profiles or both, using, e.g., the account identifier. The remote computing system 105 may generate the customized recommendation based at least in part on the customer information stored in the customer database 120, which also includes data about identified gift receives provided by the customers (herein gift receivers are also referred to as simply “customer”). As new customer interests or updated customer information is received, the remote computing system 105 may be configured to update the customer database 120 and generate updated customized recommendations. A complete list of customer interests may be stored in one or more databases, such as the customer database 120 or another database, accessible to the remote computing device 105.

In one exemplary implementation, the remote computing system 105 may implement a heuristic that considers the customer's interests. The heuristic may have the remote computing system 105 consult a lookup table that maps customer interests to particular products. The lookup table may map products to customer interests based on features of the product or whether other customers with similar interests have purchased the product. Thus, the heuristic may determine whether any products or services are particularly suited to one or more customer interests, and if so, include those products in the customized recommendation. The heuristic may be updated periodically to map customer interests to different products, e.g., when new products become available.

By way of example, a customer who is interested in running may appreciate recommendations for products that support that hobby. The lookup table may map the customer interest of “running” to products with features that can be used while running (e.g., products that play music, track distance using GPS, etc.) as well as accessories that make the product more conducive to use while running (sweat-proof armbands, for example). Additionally, the lookup table may recognize that many customers who enjoy running purchase the same few products and include such products in the customized recommendation. Upon recognition of “running” as a customer interest, the remote computing system 105 may consult the lookup table for products associated with “running ” The remote computing system 105 may be configured to generate the customized recommendation with the products that are associated with “running” in the lookup table.

In one possible implementation, the remote computing device 105 may be configured to identify a hierarchical relationship between two or more customer interests. Thus, subcategories may exist for each type of customer interest. For example, a customer interest acting as a “root” in the hierarchy may include “sports.” Categories of “sports” may include “football,” “baseball,” “basketball,” etc. Within each of these categories may be different organizations (NFL®, MLB®, NBA®) or team names (e.g., New York Giants® may be a subcategory under the “football” category), for example. Each level in the hierarchy may be mapped to products or services using the heuristic described above. Thus, the selection of “football” as a customer interest may generate a different customized recommendation than the selection of “baseball” as the customer interest.

The customized recommendation may include services in addition to or instead of products. For instance, customized recommendations for a customer with children who play sports may include products with video capture capability and a data plan that allows the customer to upload the videos to, e.g., a social networking website. The lookup table, therefore, may map services (e.g., the ability to upload videos) to particular customer interests (e.g., “children who play sports”).

The customer information may further include an identification of previous products the customer has purchased. Such products may be considered by the remote computing system 105 when generating the customized recommendation. For example, the customized recommendation may include an identification of one or more products previously purchased by the customer. In addition or in the alternative, the customized recommendation may intentionally exclude one or more previously purchased products. The customer information may further include an indication of products that the customer has previously declined. Previously declined products may include products that the customer has no interest in purchasing. These may include products the customer has already considered but decided against purchasing for one reason or another. The remote computing system 105 may filter declined products from future customized recommendations for that customer. The remote computing system 105 may therefore provide unique customized recommendations for each customer profile.

Each of the mobile devices 110 may be configured to present the customer information, customer profiles, representations of potential customer interests, customized recommendation, etc., to representatives at a point of sale. In one possible approach, the mobile device 100 is configured to receive an gift application from the remote computing system 105 over the communication network 115 using, for instance, a transfer protocol such as hypertext transfer protocol (HTTP). The mobile device 110 may receive the account identifier from, e.g., the representative or the customer. The mobile device 110 may transmit the account information to the remote computing system 105, and in return, receive the customer information and customized recommendation from the remote computing system 105. The customer information may include the customer profiles, representations of selected customer interests, and representations of potential customer interests. The mobile device 110 may be configured to present the customer information and customized recommendation to the representative. Indeed, any one or more of the following may be presented to the representative via the mobile device 110: customer information, including one or more customer profiles and customer interests;

potential customer interests; a customized recommendation; previously purchased products; and previously declined products, among other information.

As the customer shares information with the representative, the customer profile may be updated in real time, using the mobile device 110, to include selected customer interests. As a result, the mobile device 110 may present updated customized recommendations that the representative can share with the customer. When the mobile device 110 receives a selection of a customer interest, or more specifically, a selection of a representation of the customer interest presented on the mobile device 100, the mobile device 110 may be configured to associate the selected customer interest to one or more of the customer profiles to generate updated customer information. The updated customer information may be transmitted to the remote computing system 105. The mobile device 110 may receive, from the remote computing system 105, an updated customized recommendation that considers the selected customer interest.

One way to receive the selection of the customer interest may be through a touch-screen display, like that found on most smart phones currently sold in the market place. The customer or the representative may, in one possible approach, select one or more icons representing potential customer interests. The selected customer interest may be associated with a customer profile by an additional selection. The selections made through the touch-screen display may be based on gestures performed by the user. For instance, selecting a customer interest may involve the user touching the icon displayed on the touchscreen. This may be referred to as a “touch” gesture.

Associating a customer interest with a customer profile may include the user “dragging” an icon representing the customer interest to a part of the user interface display presenting the customer profile. This may be referred to as a “drag” gesture. As discussed above, each customer interest may be part of a hierarchy. Therefore, the selection of one customer interest may cause the mobile device 110 to present subcategories of the selected customer interest for an additional or alternative selection, either by voice detection or manual input using the touch-screen display.

Further or in the alternative, the mobile device 110 may be configured to receive audio signals through, e.g., a microphone to identify customer interests via voice detection. The audio signals may be from a discussion between the customer and a representative whose voices may be received at the microphone. The mobile device 110 may be configured to “listen” to the audio signals for potential customer interests. Without recording the conversation, the mobile device 110 may process the audio signals and extract words associated with customer interests. For instance, the mobile device 110 may extract the word “running,” which may be a potential customer interest, from the audio signal. The mobile device 110 may then identify “running” as a potential profile element that the representative can select and associate with the customer speaking.

Any time during or after the conversation, the mobile device 110 may prompt the customer or representative to confirm any customer interests determined from the conversation. To continue with the example above, the mobile device 110 may prompt the customer or representative to confirm that the customer has an interest in running and that the customer interest icon representing “running” should be added to the customer profile. The mobile device 110 may further prompt the customer or representative to select the customer profile to which the selected customer interest should be added.

Because the customer information is synchronized with the remote computing system 105, any mobile device 110 that receives the customer information will receive the same customized recommendations. The customer will not need to repeat customer interests when communicating with a different representative during subsequent visits, over the telephone, or online, for instance. In addition, because declined products may be excluded from the customized recommendations, the customer may not be presented with products he or she has already decided not to purchase. Of course, updated information received from the customer may result in a modification of a prior decision to decline a previous recommendation. For instance, the customer may have previously declined a product with features intended for runners. The customer may have recently taken up an interest in running, and therefore, may now wish to receive recommendations for products with such features.

The communication network 115 may be configured to facilitate communication between the mobile devices 110 and the remote computing system 105. The communication network 115 may include the Internet or another type of packet-switched network, a cellular network, a Bluetooth® network, and the like. The communication network 115 may be configured to transmit information among the mobile devices 110, between the mobile devices 110 and the remote computing system 105, or both.

FIG. 2 illustrates exemplary components of an exemplary mobile device 110. As illustrated, the mobile device 110 includes a network interface device 200, a user interface device 205, an audio input device 210, and a processor 215.

The network interface device 200 may be configured to transmit and receive information over the communication network 115. The network interface device 200 may be configured for wired or wireless communication. As information is received, the network interface device 200 may be configured to output the received information to, e.g., the processor 215 or another component of the mobile device 110. The network interface device 200 may be configured to transmit account information to the remote computing system 105 and receive the associated customer information and customized recommendation from the remote computing system 105. The network interface device 200 may transmit the customer information and customized recommendation to the processor 215. Any one or more of the following types of information may pass through the network interface device 200: customer information, which may include customer profiles and an identification of customer interests; potential customer interests; a customized recommendation; previously purchased products; and previously declined products; among other information. When the customer information is updated to include, e.g., selected customer interests, the network interface device 200 may transmit the updated customer information to the remote computing system 105 and receive an updated customized recommendation from the remote computing system 105.

The user interface device 205 may be configured to receive inputs from the user and present outputs to the user. In one possible approach, the user interface device 205 may include a touch-sensitive display screen. The user interface device 205 may receive inputs from the user when the display screen is touched with, e.g., the user's finger or a stylus. Signals generated from touching the display screen may be transmitted from the user interface device 205 to the processor 215. The user interface device 205 may be further configured to receive signals from the processor 215 and generate signals that will cause a visual representation of the customer information to be displayed on the display screen. For instance, the user interface device 205 may present customer information and the customized recommendation to the customer or the representative. Additionally, the user interface device 205 may present representations of potential customer interests to the customer or representative. The potential customer interests may represent additional interests the customer may have but are not included in the customer information.

The user interface device 205 may be configured to receive a selection of one of more of the potential customer interests. Selecting one of the potential customer interests indicates that the customer identifies with the selected interest. The user interface device 205 may transmit a signal representing the selected customer interest to the processor 215.

The audio input device 210 may include a microphone or any other device configured to receive sound. The audio input device 210 may convert the received sound into audio signals that may be transmitted to the processor 215. The audio signals may represent one or more words spoken by the customer or a representative. Some of those words may relate to potential customer interests. The audio signal representing those potential customer interests may be transmitted, by the audio input device 210, to the processor 215 so those potential customer interests may be extracted from the audio signal. Before transmitting the audio signal, the audio input device 210 may be configured to filter the received sound during the conversion of the received sound into audio signals. An example of filtering may include removing background noise.

The processor 215 may be configured to receive and process various signals. The processor 215 may receive signals from the network interface device 200, the user interface device 205, and the audio input device 210. The processor 215 may process the signals received and transmit processed signals to, e.g., the network interface device 200 for transmission to the remote computing system 105 or to the user interface device 205 for presentation to the customer or representative. In one possible implementation, the processor 215 may be configured to receive a signal, from the user interface device 205, which represents a selection of a potential customer interest. The processor 215 may associate the selected customer interest with one of the customer profiles to generate updated customer information. The updated customer information may be transmitted from the processor 215 to the network interface device 200 so that it may ultimately be sent to the remote computing system 105.

Another way to select customer interests may be from the audio signal received from the audio input device 210. As mentioned above, the audio signal may represent potential customer interests based on words spoken by the customer or representative. The processor 215 may receive and process the audio signal to extract customer interests. Any customer interests identified from the audio signal may be interpreted as selected customer interests. The processor 215 may output a signal, to the user interface device 205, which indicates that a customer interest was extracted from the audio signal so, e.g., the selected customer interest may be confirmed by the customer or representative.

The remaining figures illustrate exemplary user interface displays that may be presented to the customer or representative during use of the mobile device 110. Because the mobile device 110 may be used at the point of sale, only certain information may be presented at the top layer. An interaction may be required to access confidential information that is used for validation. For instance, certain confidential customer information, such as the customer's address, social security number, credit card information, etc., may be excluded or require interaction by the representative to reveal.

In general review, a mobile gift application is disclosed herein in a preferred embodiment that helps users to find the perfect gift for anyone. In general the user enters in a budget range and then selects answers about the recipient ranging from gender and age to hobbies and interests. The gift application then generates a list of choices which include pictures, prices, and details of the items. The gift application will only locate gifts within the specified price range, which may include other costs like shipping and handling and taxes. If the gift application, however, can't find anything, then based on the individual's preferences, it'll suggest the best type of gift card to get instead.

Whomever uses the mobile gift application is able to assign a unique identity to the individual they are shopping for; and they would make the purchase from the site directly, but as soon as they make the purchase, the gift application would link that saved gift to that individual. This way the user avoids buying the same gift twice. Also, the user registers with the gift application by answering some basic information about themselves so that they can create a User ID and Password. Once the User logs in and starts saving individuals to link gifts to, they will have a list of their friends, family members, colleagues, etc. and the gifts given/purchased for each would be on it (i.e. there would be a “Saved List” and when the user clicks on the button for it, it'll show a list of names, he/she clicks on the name and then the list of which gifts have been given and for which occasion will appear for them).

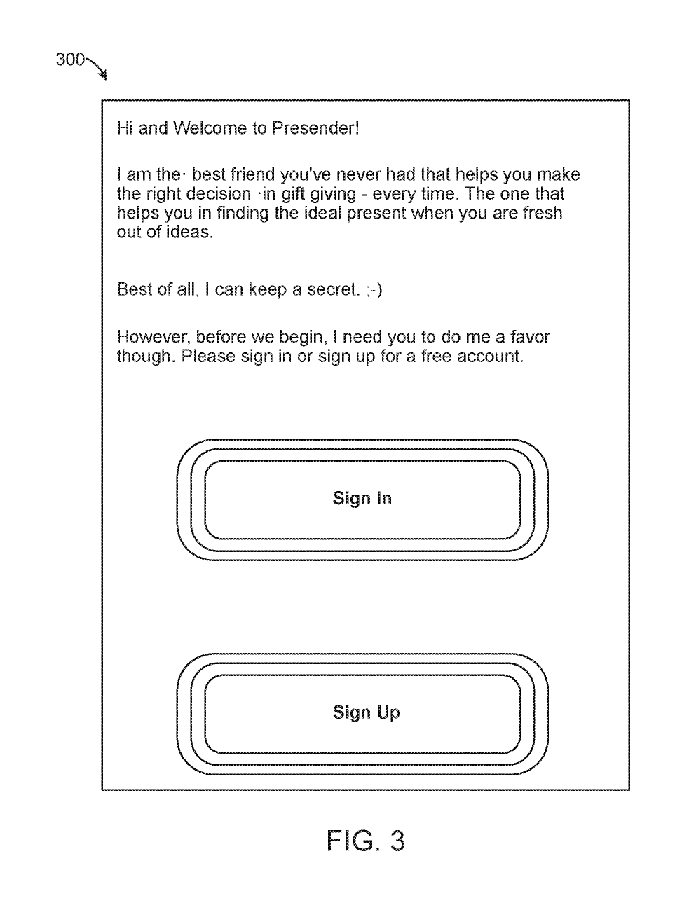

Turning now to FIG. 3, there is illustrated an exemplary display 300 that may be presented to a representative after inputting a customer's account identifier. The exemplary display 300 is a first step in the illustrated embodiment, to sign in or sign up for the free account.

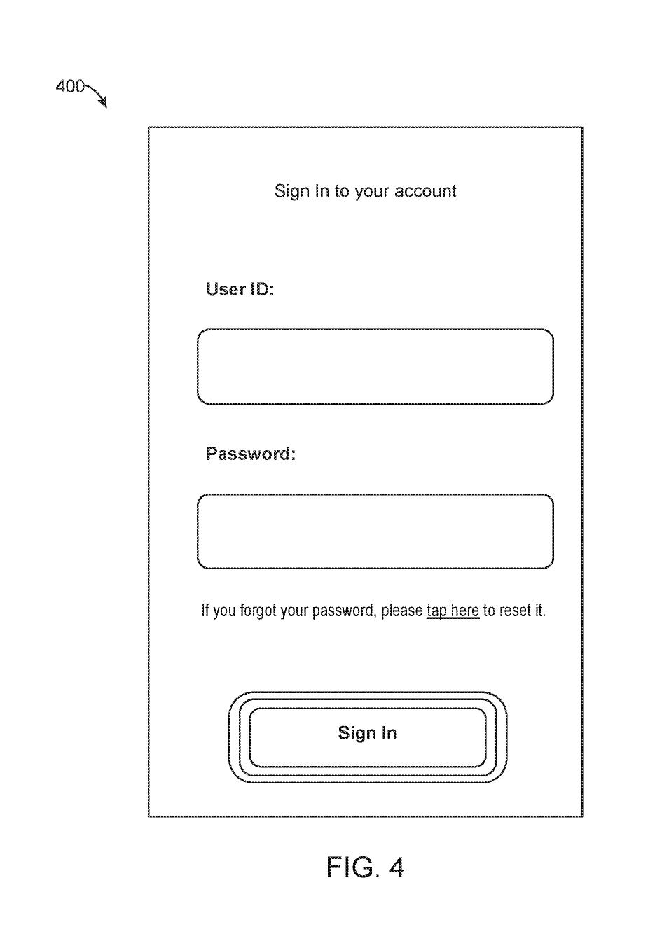

FIG. 4 illustrated one embodiment of an exemplary display 400 that enables a user to sign in with their user ID and password.

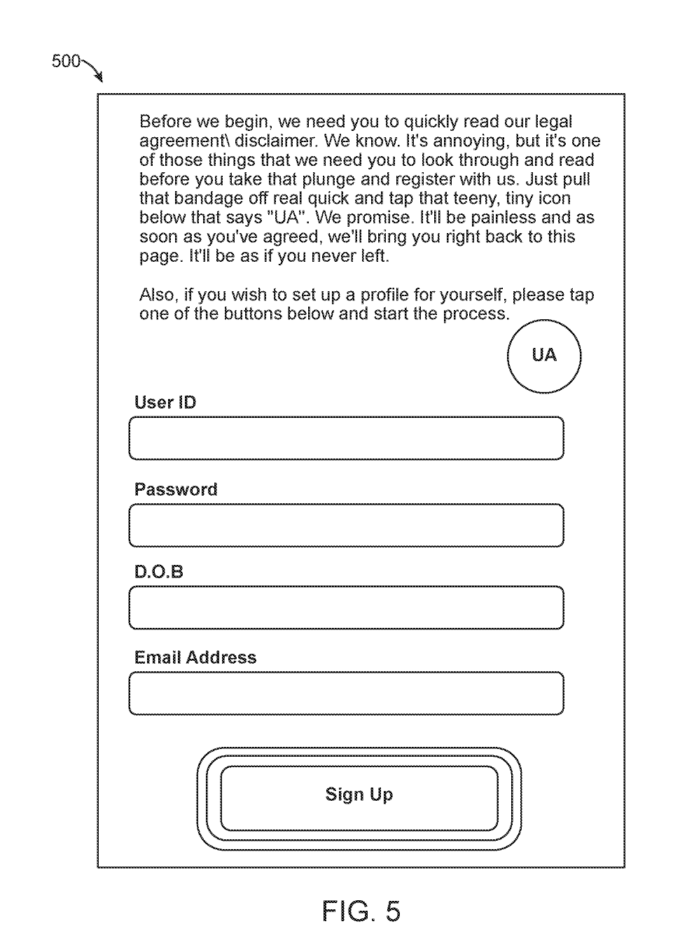

FIG. 5 illustrated one embodiment of an exemplary display 500 that enables a user to review the legal agreement and disclaimer and to start a set up of a user profile with a D.O.B. (date of birth) and email address.

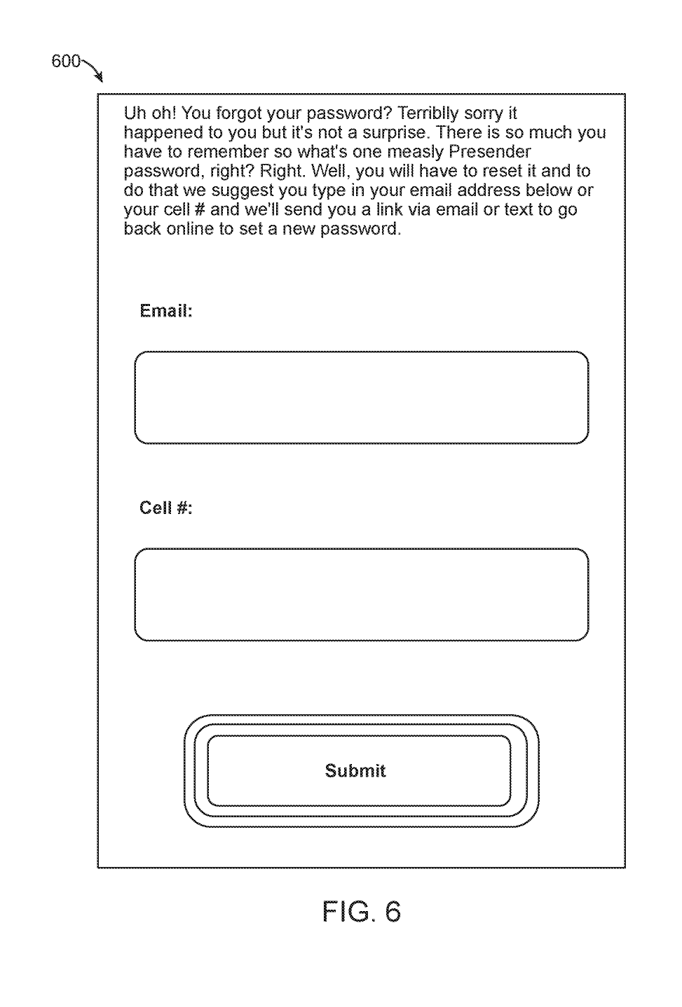

FIG. 6 illustrated one embodiment of an exemplary display 600 that enables a user that has forgotten their password to get a new one or find the old one by providing their email or cell number.

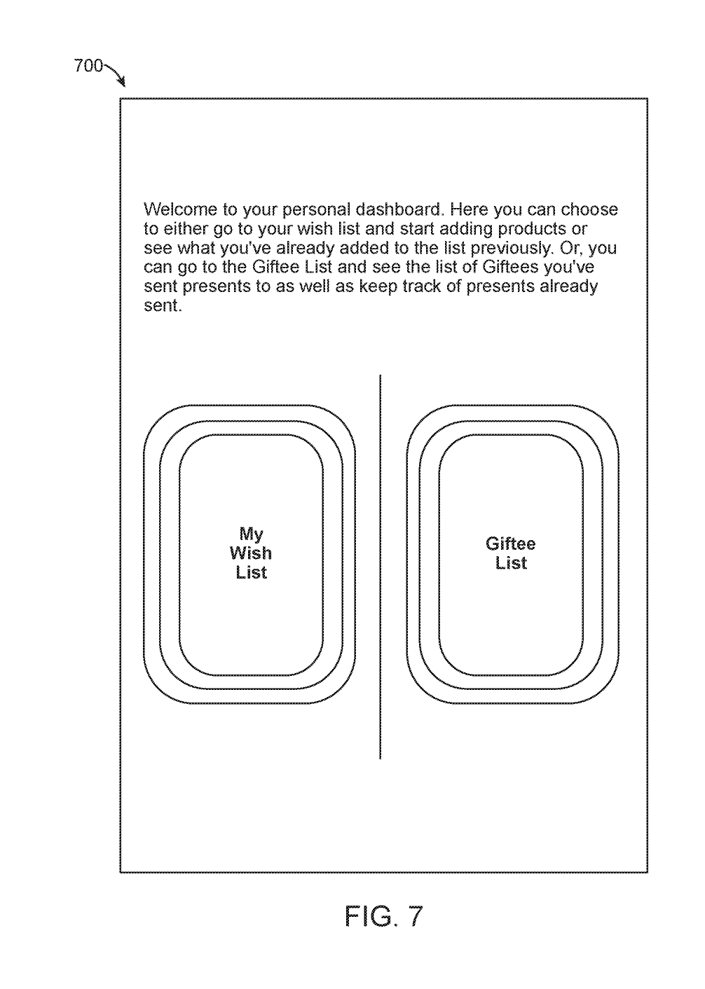

FIG. 7 illustrated one embodiment of an exemplary display 700 that enables a user to have a personal dashboard to choose to go to their wish list to add products or see what has already been added to the list. Also, the user may go to their giftee list and see the list of giftees that have received presents and to see what presents have already been sent; wherein, both of these actions are enabled by selecting the appropriate buttons illustrated.

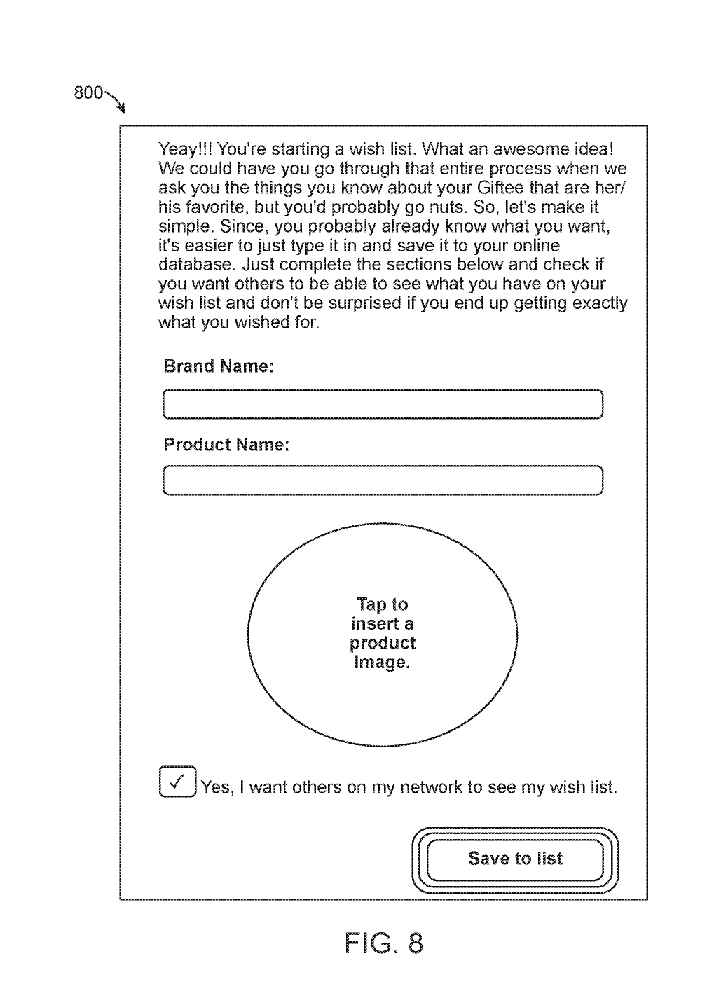

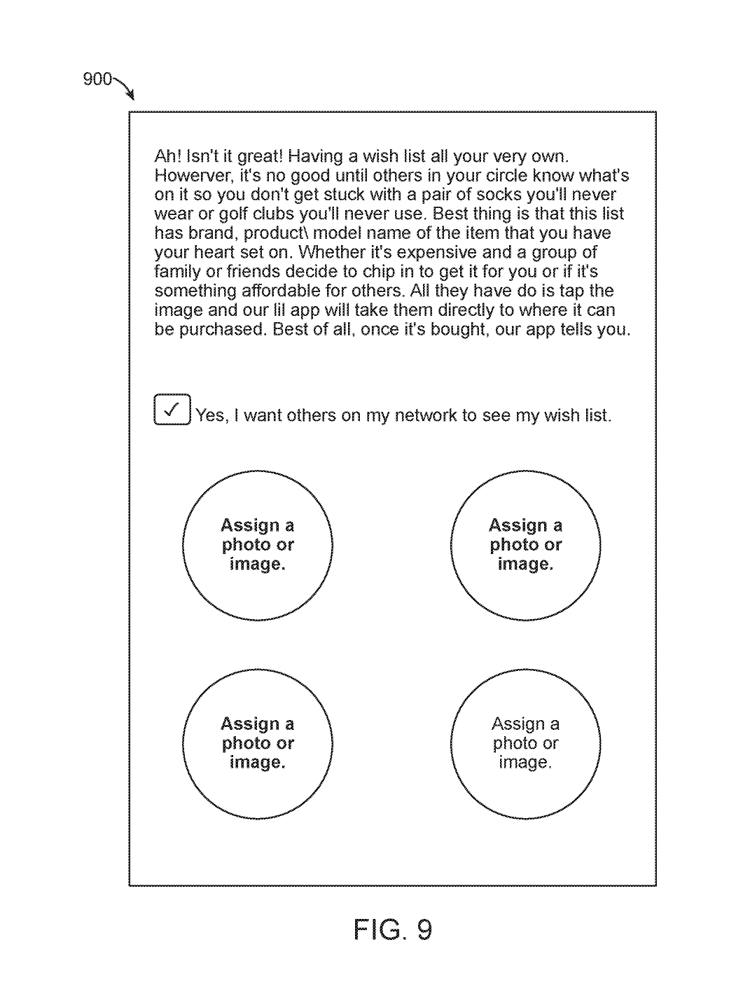

FIG. 8 illustrated one embodiment of an exemplary display 800 that enables a user to add products they know that they want, and save it to their online database. So, data entered can be selected to be shared with others, so others can see what the user is looking for in a gift. Thus the user can add brand names and product names in the provided spaces on the display 800, which also includes adding product images, and allowing the user to select if others in the users network to see the wish list.

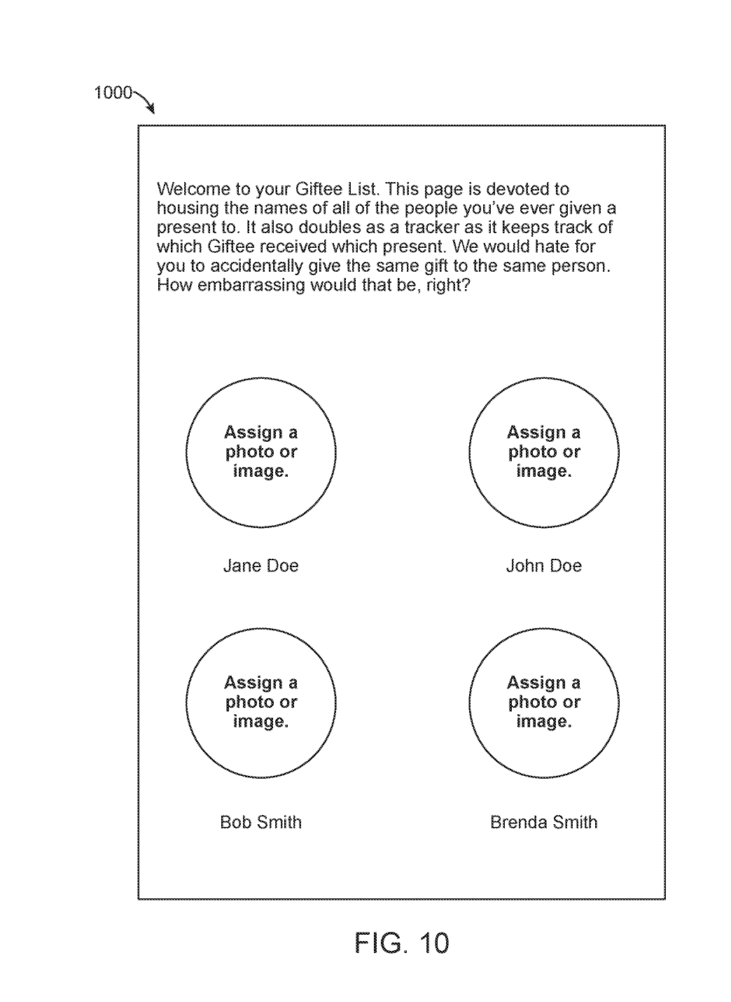

FIG. 9 illustrated one embodiment of an exemplary display 900 that enables a user to see when a gift for them has been purchased by a single or group (called friends) of those on the users network. There is illustrated an easy way for the friends to select the gift by simply taping on an image located on this display 900 and the application will take the friends directly to where the product can be purchased, and subsequently sent to the user.

FIG. 10 illustrated one embodiment of an exemplary display 1000 that enables a user to list all of the people (giftees) that the user has given gifts to. This display page (display) also doubles as a tracker as it keeps track of which giftee received which present or gift and potentially for which occasion and on what date it was given. This giftees are displayed by name and potential photo of image.

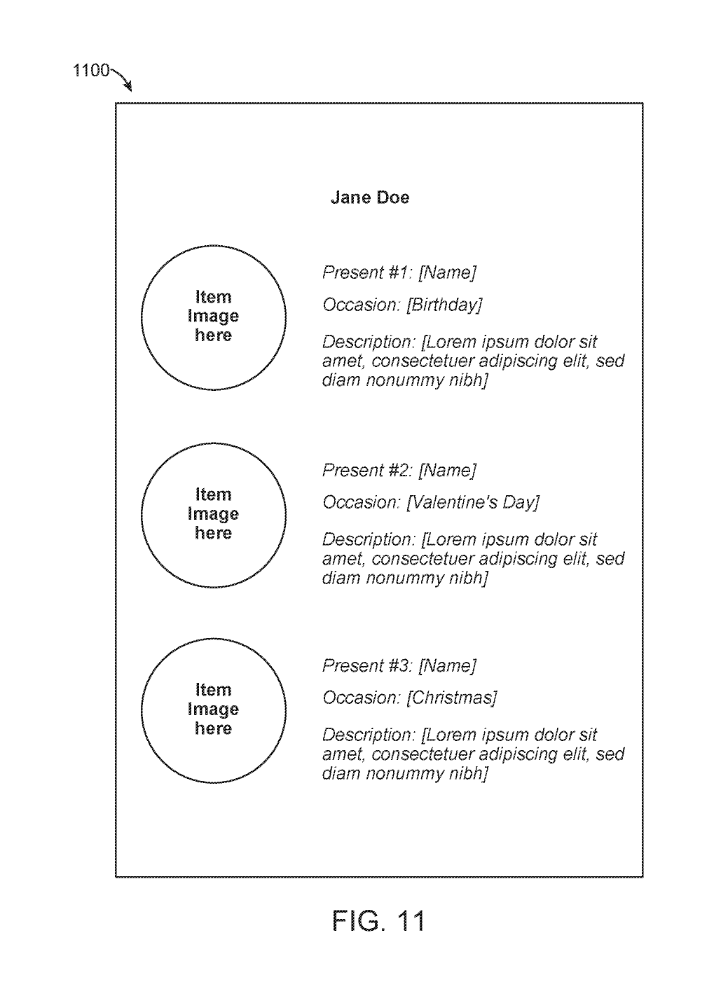

FIG. 11 illustrated one embodiment of an exemplary display 1100 that enables a user to display more data about the particular gift. The user may display an item image, a name of the gift, the occasion, and a description of each of any number of gifts that were given in the past.

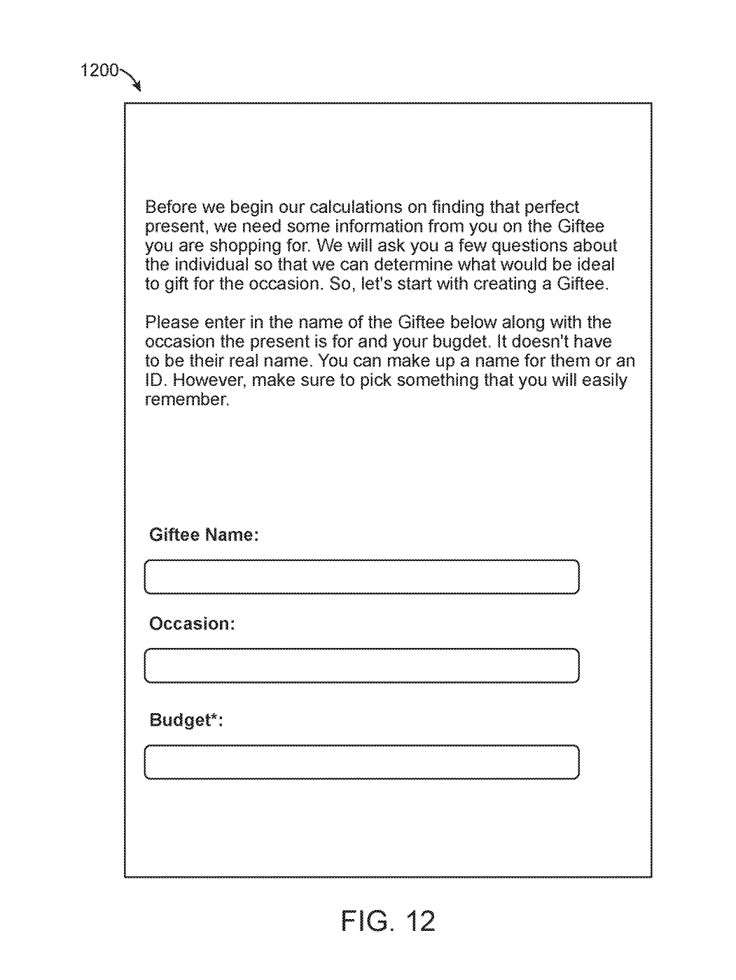

FIG. 12 illustrated one embodiment of an exemplary display 1200 that enables a user to begin a calculation used for finding a perfect present. This begins by asking key questions about the individual (giftee) so that they can determine what would be an ideal gift for the occasion. This is done by creating a database on the giftee, including the occasion the present is for and the budget planned for the giftee. Fake names may be used and fake identifications.

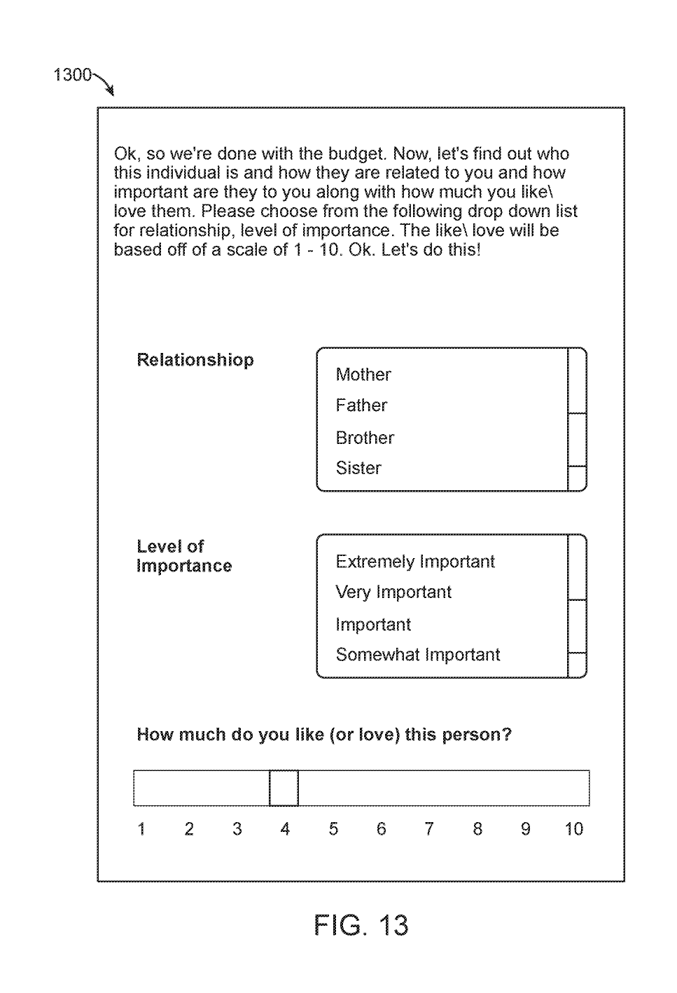

FIG. 13 illustrated one embodiment of an exemplary display 1300 that enables a user to identify and place into the database information about who the individual is and how they are related to the user and how important are they to the user along with how much the user likes or loves them. There is a dropdown list of relationships, and level of importance. For example, relationships may be: mother, father, brother, sister, friend, etc. The like or love rating will be based off of a scale of 1 to 10. There is also a level of importance rating, for example, ranging from: extremely important, very important, important, somewhat important.

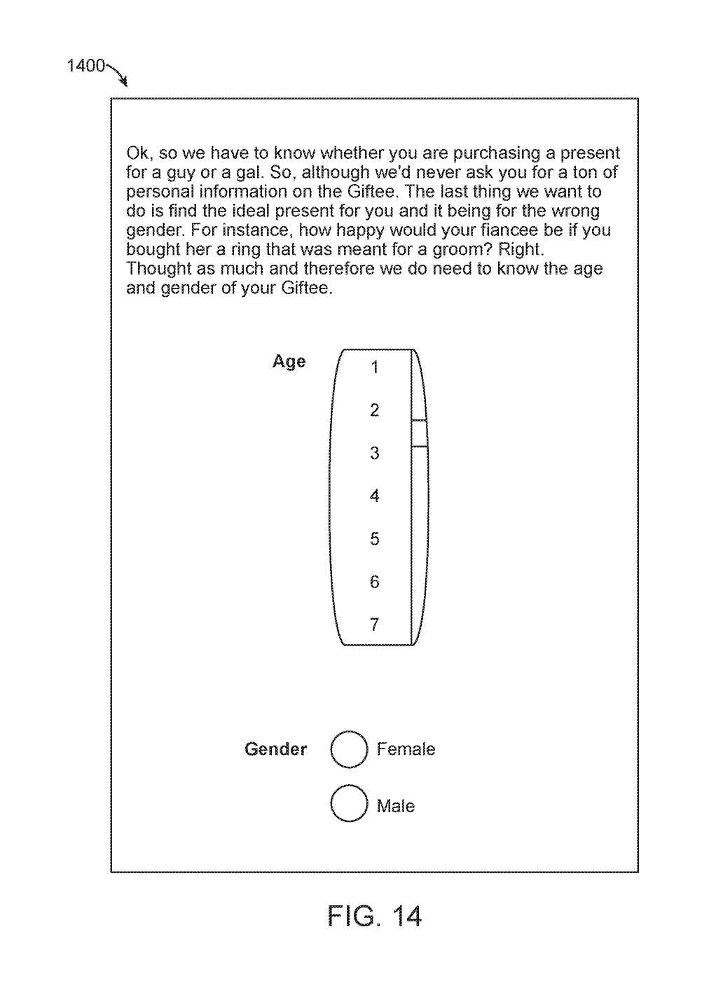

FIG. 14 illustrated one embodiment of an exemplary display 1400 that enables a user to collect data about the gender and age of the giftee.

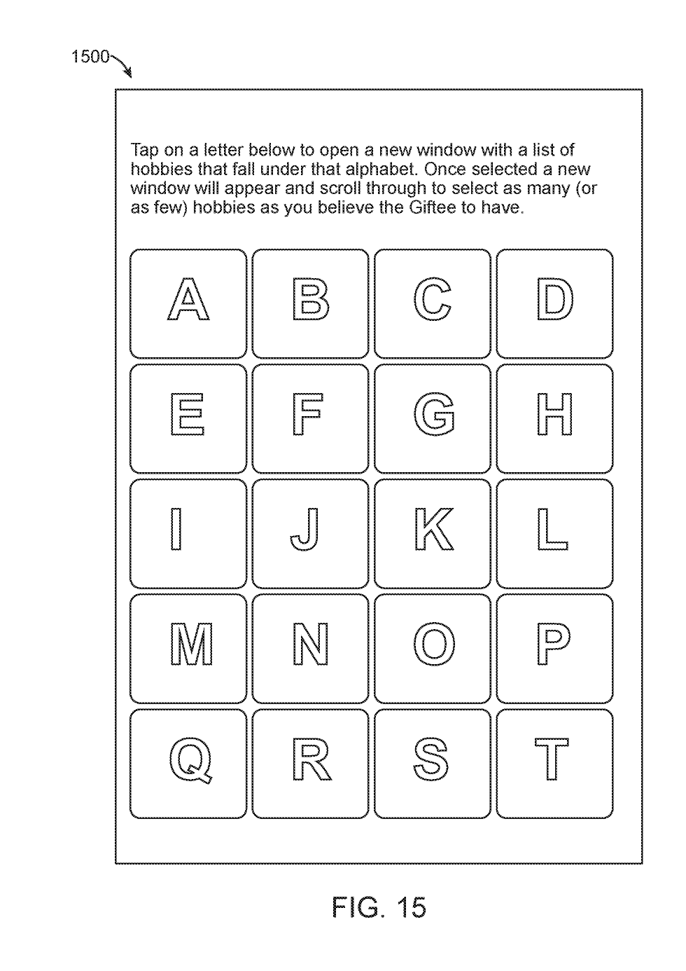

FIG. 15 illustrated one embodiment of an exemplary display 1500 that enables a user to record a list of hobbies related to a giftee. This is done by selecting a letter of the alphabet and displaying a list of hobbies under that letter. For example, under the letter “B” there could be listed: baseball, basketball, beach volleyball, badminton, etc. Whereby, selection of the appropriate hobbies of the giftee will provide possible connections to potential gifts that are related to that hobby.

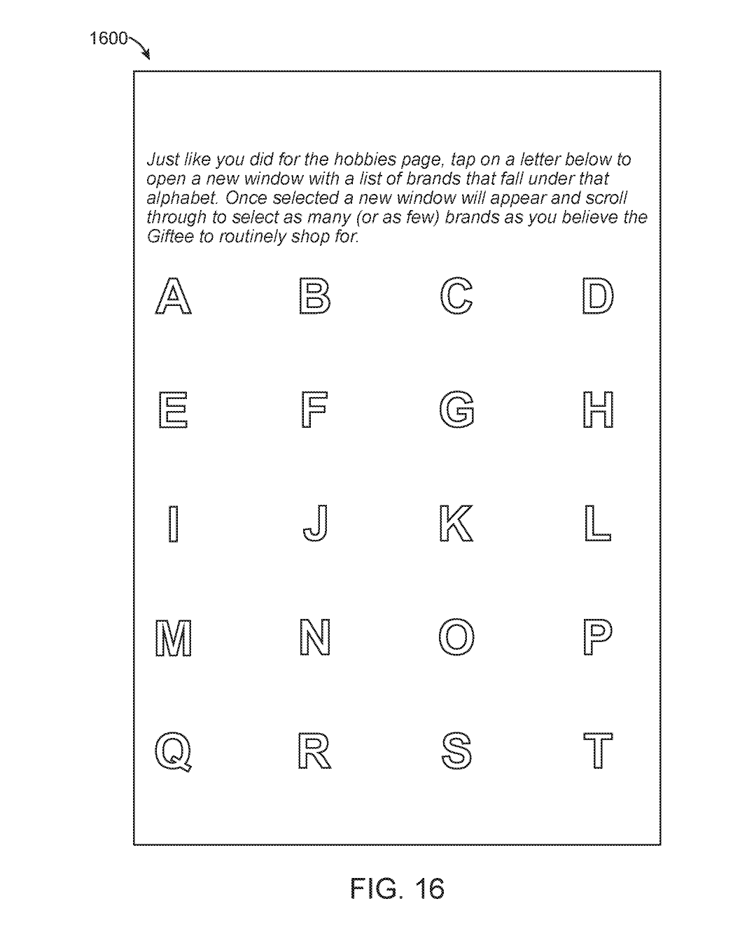

FIG. 16 illustrated one embodiment of an exemplary display 1600 that enables a user to record, like hobbies, a list of product brands that fall under the alphabet list. Thus the user can scroll through the displayed letters and select the brands listed under those letters that would be associated with that giftee. For example, under the letter “C” for a person that likes to go fishing, the brand CABELLAS could be selected as it is the name of a fishing outfitters store and clothing brand.

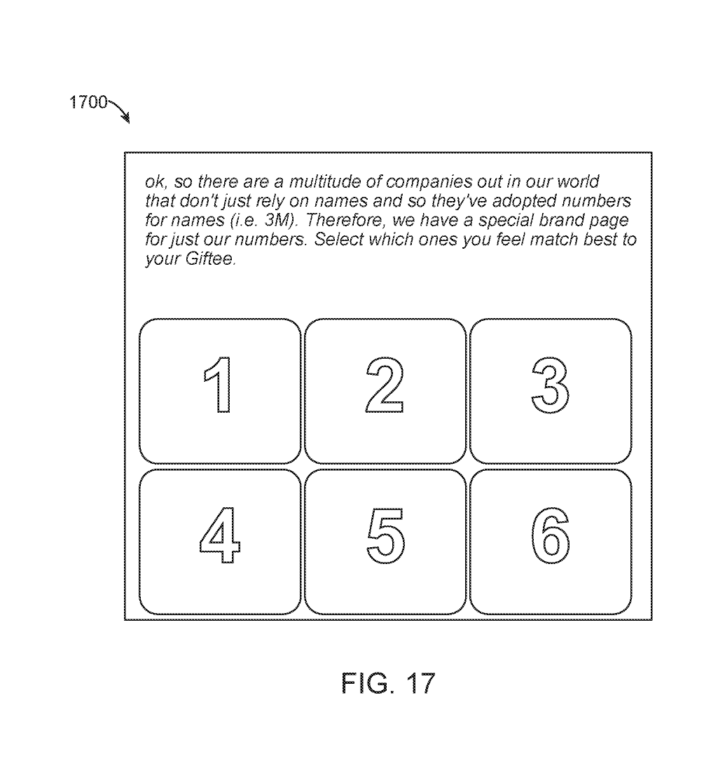

FIG. 17 illustrated one embodiment of an exemplary display 1700 that enables a user to, just like hobbies again, tap on the illustrated numbers to open a new window with a list of companies out in the world that don't just rely on names and so they've adopted numbers for names, like 3M. Therefore, this is a special brand page that uses numbers, which are to be associated with the selected giftee.

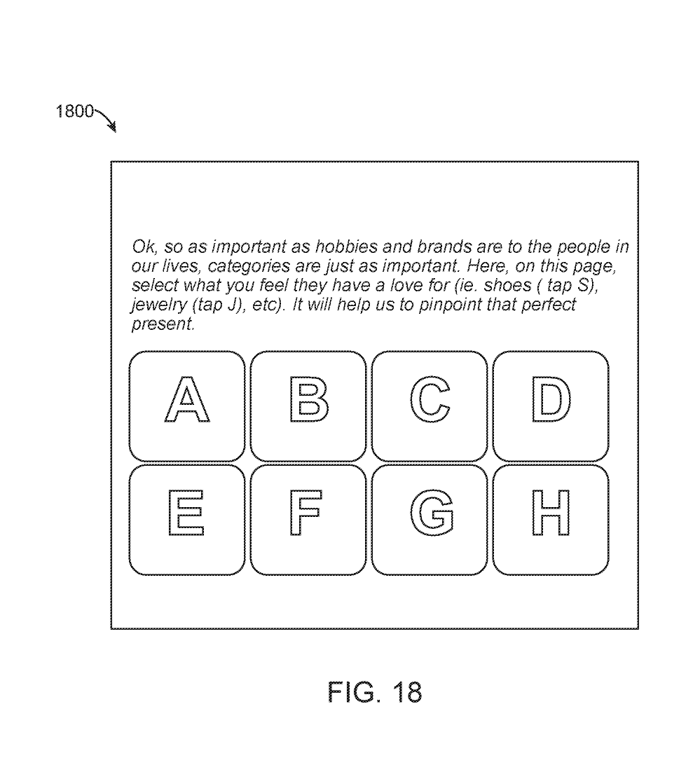

FIG. 18 illustrated one embodiment of an exemplary display 1800 that enables a user to associate categories of items to the giftee. For example, under the letter “S” there could be listed “shoes” and “sweaters”.

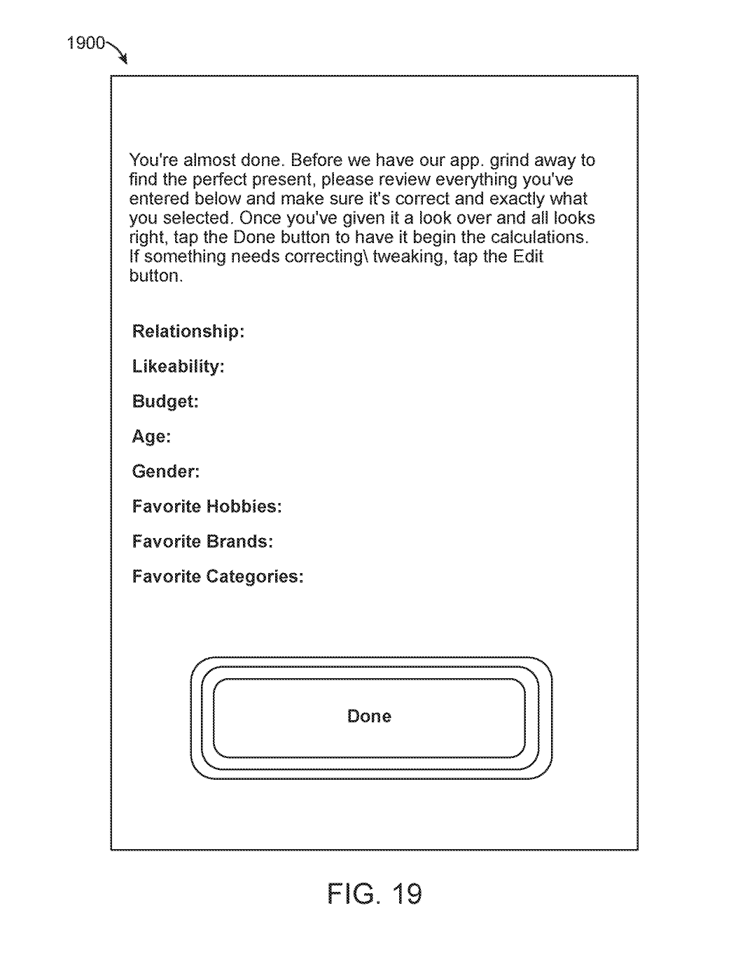

FIG. 19 illustrated one embodiment of an exemplary display 1900 that enables a user to review all the data collected about the giftee's preferences for the perfect gift. Thus, once the user has reviewed the data, they just tap the DONE button provided to begin the calculations and identification of suggested gifts.

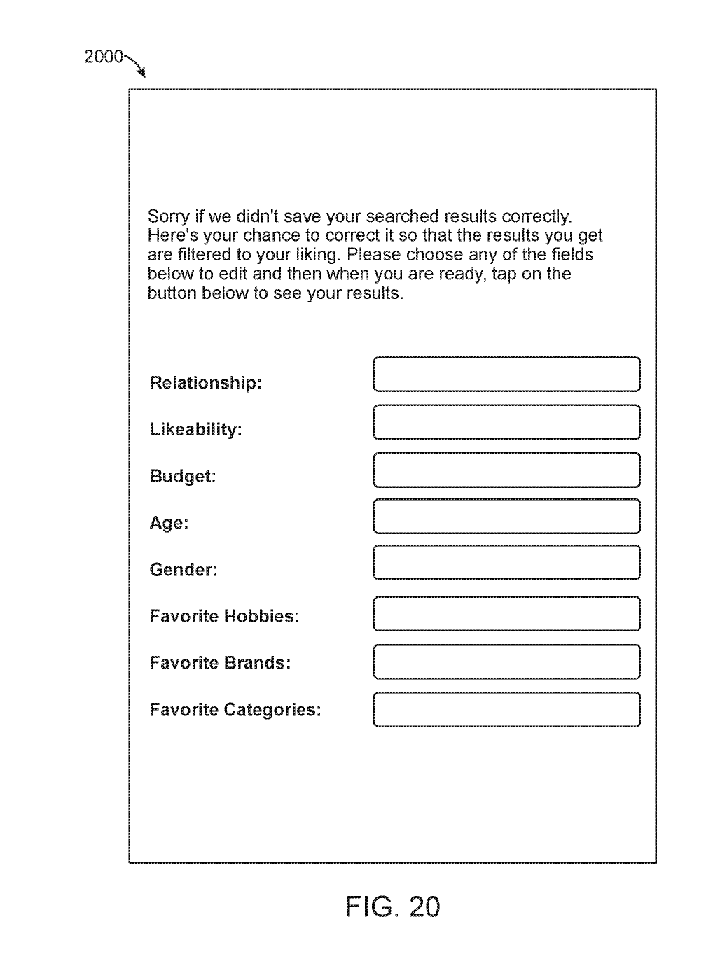

FIG. 20 illustrated one embodiment of an exemplary display 2000 that enables a user to correct the results of any previous information. Whereby, for example, displayed are the major categories of: relationship, likeability, budget, age, gender, favorite hobbies, favorite brands, and favorite categories.

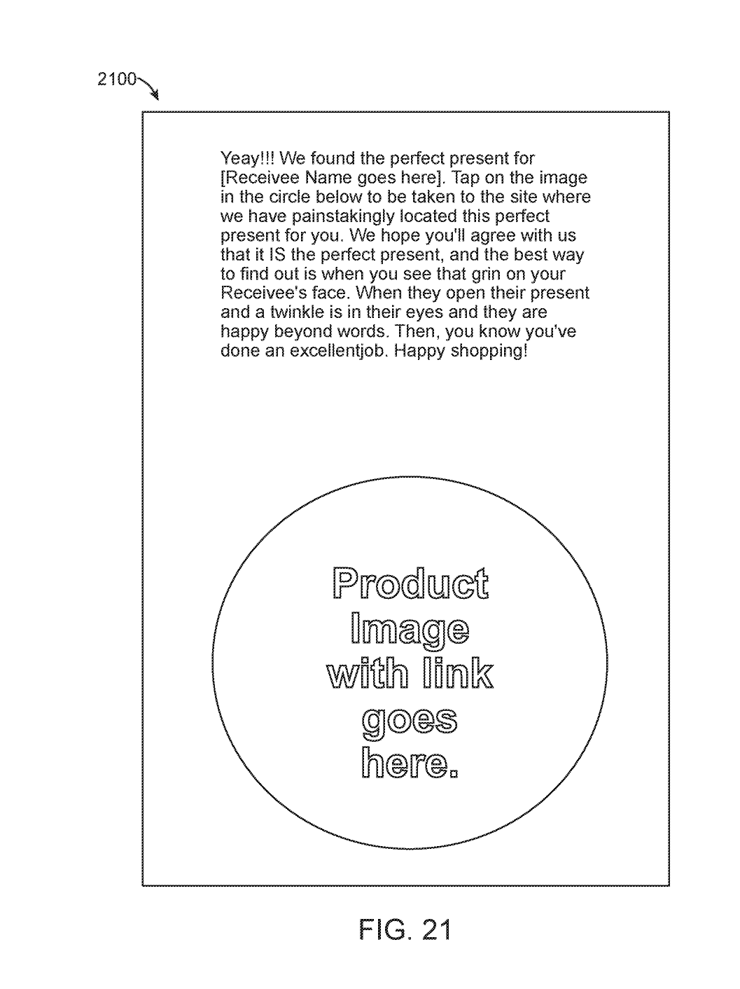

FIG. 21 illustrated one embodiment of an exemplary display 2100 that enables a user to view the resulting perfect present for the giftee. Whereby, an image of the present is displayed, and by tapping on the image the user will be provided information on where that item may be purchased, and preferably provide a list of closest and most convenient locations, or on line purchase sites that will deliver the selected gift.

It is noted that if there are no gifts that are available or desirable for the user to purchase, the illustrated invention will display a list of gift chards that may be purchased that fit the giftee preferences.

It is further noted that one skilled in the art will realize the usefulness of this invention. The illustrated embodiment provides a teaching of a device that can keep track of past and future gifts for friends and family and tell others what gifts you would like to receive. The illustrated embodiment provided herein teaches of collecting pertinent data about the user, and their friends and family. The illustrated invention associates gift information with those persons. The invention teaches of saving past gift information to prevent duplication. Current gift desires are communicated to a users network of friends and family. Once a gift is identified a location for purchase of those gifts is provided. All of the services, data, and information may be placed on a smartphone or computer device and networked with other users.

What is claimed is new and desired to be protected by Letters Patent is set forth in the appended claim:

1. A gift generating device for a user, comprising:
a) a computing system, configured to store giftee information in a customer database, wherein the giftee information is associated with a selected giftee, and wherein the computing system is configured to generate a customized gift recommendation based on the giftee information; and
b) a mobile device, used by the user, in communication with the computing system, configured to:
i) transmit the giftee information to the computing system from the user;
ii) receive the customized gift recommendation associated with the giftee information from the computing system; and
iii) receive purchase locations for the customized gift recommendation from the computing system.

2. The device of claim 1, wherein the giftee information is selected from the group of questions consisting of: hobbies, brands, companies, categories of products, budget, past gifts, occasion, level of importance, relationship to user, likability, gender, and age.

3. The device of claim 2, wherein the purchase locations are locations that are relatively close to the user.

4. The device of claim 3, wherein the computing system further transmits the customized giftee information to other users that are in a communication network with the user.

5. The device of claim 4, wherein the mobile device additionally transmits user gift information to the computing system from the user.

6. The device of claim 5, wherein the giftee information about hobbies is identified by enabling the user to select a letter of the alphabet and thereby displaying a list of hobbies that begin with that letter and thereby allow the user to select the hobby.

7. The device of claim 6, wherein the user via the mobile device enters a list of past gifts sent to the giftee and transmits that past list to the computing system and thereby enables displaying of the past list of gifts associated with the selected giftee to the user when desired.

8. The device of claim 7, wherein the giftee information about likeability is identified by enabling the user to select a number between 1 and 10.

9. The device of claim 8, wherein the giftee information about level of importance is identified by enabling the user to select from a group of answers consisting of: extremely important, very important, important, and somewhat important.

10. A gift generating system for a user, comprising:
a) a computing system, configured to store giftee information in a customer database, wherein the giftee information is associated with a selected giftee, and wherein the computing system is configured to generate a customized gift recommendation based on the giftee information; and
b) a mobile device, used by the user, in communication with the computing system, configured to:
i) transmit the giftee information to the computing system from the user;
ii) receive the customized gift recommendation associated with the giftee information from the computing system; and
iii) receive purchase locations for the customized gift recommendation from the computing system.

11. The system of claim 10, wherein the giftee information is selected from the group of questions consisting of: hobbies, brands, companies, categories of products, budget, past gifts, occasion, level of importance, relationship to user, likability, gender, and age.

12. The system of claim 11, wherein the purchase locations are locations that are relatively close to the user.

13. The system of claim 12, wherein the computing system further transmits the customized giftee information to other users that are in a communication network with the user.

14. The system of claim 13, wherein the mobile device additionally transmits user gift information to the computing system from the user.

15. The system of claim 14, wherein the giftee information about hobbies is identified by enabling the user to select a letter of the alphabet and thereby displaying a list of hobbies that begin with that letter and thereby allow the user to select the hobby.

16. The system of claim 15, wherein the user via the mobile device enters a list of past gifts sent to the giftee and transmits that past list to the computing system and thereby enables displaying of the past list of gifts associated with the selected giftee to the user when desired.

17. The system of claim 16, wherein the giftee information about likeability is identified by enabling the user to select a number between 1 and 10.

18. The system of claim 17, wherein the giftee information about level of importance is identified by enabling the user to select from a group of answers consisting of: extremely important, very important, important, and somewhat important.
